(19) United States
(12) Patent Application Publication
(10) Pub. No.: US 2025/0304441 A1
(43) Pub. Date: Oct. 2, 2025

(54) DEVICE AND METHOD FOR PRODUCING HYDROGEN

(71) Applicants: HYUNDAI MOTOR COMPANY, Seoul (KR); KIA CORPORATION, Seoul (KR)

(72) Inventors: Jun Ho Jang, Seongnam-si (KR); Jung Joo Park, Seoul (KR)

(73) Assignees: HYUNDAI MOTOR COMPANY, Seoul (KR); KIA CORPORATION, Seoul (KR)

(21) Appl. No.: 18/777,035

(22) Filed: Jul. 18, 2024

(30) Foreign Application Priority Data
Mar. 27, 2024 (KR) 10-2024-0041980

(51) Int. Cl. C01B 3/38; C01B 3/48

(52) U.S. Cl. CPC C01B 3/382; C01B 3/48; C01B 2203/0233; C01B 2203/0238; C01B 2203/0283; C01B 2203/042; C01B 2203/0475; C01B 2203/1241; C01B 2203/1258; C01B 2203/142; C01B 2203/148

(57) ABSTRACT

A device and a method for producing hydrogen are disclosed. The device includes a reformer that generates a first gas containing hydrogen and carbon monoxide by inducing a first reaction of methane and carbon dioxide contained in biogas and a second reaction of methane contained in biogas and separately supplied water. The device also includes a water gas shifter that generates a second gas containing hydrogen and carbon dioxide by inducing a third reaction of carbon monoxide contained in the first gas and separately supplied water.

### CROSS-REFERENCE TO RELATED APPLICATION

This application claims the benefit of priority to Korean Patent Application No. 10-2024-0041980, filed in the Korean Intellectual Property Office on Mar. 27, 2024, the entire contents of which are incorporated herein by reference.

### TECHNICAL FIELD

The present disclosure relates to a device and a method for producing hydrogen that may have excellent hydrogen production yield as dry reforming and wet reforming proceed simultaneously by separately supplying water during a reforming reaction of biogas containing methane and carbon dioxide, and may reduce an occurrence of coking caused by thermal decomposition of methane.

### BACKGROUND

Hydrogen gas is receiving attention as an eco-friendly energy source. As a result, various methods for producing hydrogen gas have been proposed. Among the methods for producing hydrogen gas, a method for producing hydrogen from biogas is environmentally friendly in that biogas, which is a waste product, is used. In addition, the method for producing hydrogen from biogas typically includes a process of concentrating methane in biogas, then performing purification to remove impurities such as moisture and a sulfur compound, and then performing reforming treatment.

Recently, a dry methane reforming method (CH₄+CO₂→2H₂+2CO), which produces hydrogen by reacting methane in biogas with carbon dioxide, which is a greenhouse gas, and which simultaneously offsets carbon dioxide, has been attracting attention. For example, in Korean Patent Application Publication No. 2023-0106305 (Patent Document 1), a hybrid system is disclosed that includes: a carbon dioxide separating membrane that separates biogas into methane and carbon dioxide; a reforming reactor that produces synthesis gas by receiving methane and carbon dioxide; a hydrogen separating membrane that receives synthesis gas and separates hydrogen therefrom; and a water gas generator that receives carbon monoxide separated from the hydrogen separating membrane, and converts the carbon monoxide into water gas as water is supplied to one side thereof. However, compared to a widely used wet methane reforming method, the dry methane reforming method as described in Patent Document 1 has a problem in that hydrogen production yield is low because of low catalytic activity or low reactivity caused by formation of coke on a catalyst.

### SUMMARY

Therefore, there is a need for research and development on a method for producing hydrogen from biogas and a device using the same with less reactivity reduction and excellent hydrogen production yield resulted from reduction in coking occurrence.

The present disclosure has been made to solve the above-mentioned problems occurring in the prior art while advantages achieved by the prior art are maintained intact.

Aspects of the present disclosure provide a device and a method for producing hydrogen that may prevent a decrease in activity of a reforming catalyst as an occurrence of coking caused by thermal decomposition of methane in biogas containing methane and carbon dioxide is reduced and that may have excellent hydrogen production yield as a reforming reaction of methane progresses more actively.

The technical problems to be solved by the present disclosure are not limited to the aforementioned problems. Any other technical problems not mentioned herein should be more clearly understood from the following description by those of ordinary skill in the art to which the present disclosure pertains.

According to an aspect of the present disclosure, a device for producing hydrogen includes a reformer that generates a first gas containing hydrogen and carbon monoxide by inducing a first reaction of methane and carbon dioxide contained in biogas and by inducing a second reaction of methane contained in biogas and separately supplied water. The device also includes a water gas shifter that generates a second gas containing hydrogen and carbon dioxide by inducing a third reaction of carbon monoxide contained in the first gas and separately supplied water.

According to another aspect of the present disclosure, a method for producing hydrogen includes a reforming step of generating a first gas containing hydrogen and carbon monoxide from a first reaction of methane and carbon dioxide contained in biogas and from a second reaction of methane contained in biogas and separately supplied water. The method also includes a water gas shifting step of generating second gas containing hydrogen and carbon dioxide by reacting carbon monoxide contained in the first gas with separately supplied water.

### BRIEF DESCRIPTION OF THE DRAWINGS

The above and other objects, features, and advantages of the present disclosure should be more apparent from the following detailed description taken in conjunction with the accompanying drawings:

FIGS. 1-9 are flowcharts of a hydrogen producing device according to an embodiment of the present disclosure.

### DETAILED DESCRIPTION

The present disclosure is described in detail below.

When a component, device, element, or the like of the present disclosure is described as having a purpose or performing an operation, function, or the like, the component, device, or element should be considered herein as being “configured to” meet that purpose or perform that operation or function.

Herein, when a certain portion “includes” a certain component, this means that the certain portion may further include other components without excluding said other components unless otherwise stated.

Herein, when a first member is located on a “surface”, “one surface”, “the other surface” or “both surfaces” of a second member, this includes not only a case in which the first member is in contact with the second member, but also a case in which a third member exists between the two members.

Unless specifically stated or apparent from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

### Device for Producing Hydrogen

The hydrogen producing device according to the present disclosure includes a reformer and a water gas shifter.

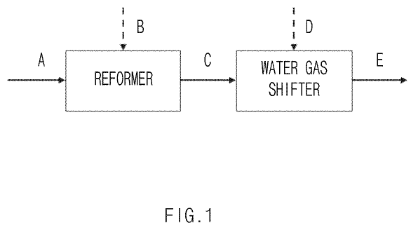

Referring to FIG. 1, the hydrogen producing device according to the present disclosure is supplied with biogas ‘A’ and water ‘B’ and ‘D’, and includes the reformer and the water gas shifter.

The hydrogen producing device sequentially includes the reformer and the water gas shifter. Thus, a water gas shift reaction proceeds after a reforming reaction of methane, resulting in excellent hydrogen production yield.

### Reformer

The reformer generates a first gas containing hydrogen and carbon monoxide by inducing a first reaction of methane and carbon dioxide contained in biogas and a second reaction of methane contained in biogas and separately supplied water. Referring to FIG. 1, the biogas ‘A’ and the water ‘B’ are supplied to the reformer. The first reaction and the second reaction are induced to generate first gas ‘C’ containing hydrogen and carbon monoxide.

Specifically, in the reformer, the first reaction (CH₄+CO₂→2H₂+2CO), which is a dry reforming reaction (DR) in which methane and carbon dioxide react, and the second reaction (CH₄+H₂O→3H₂+CO), which is a wet reforming reaction (steam methane reforming (SMR)) in which methane and water react are performed simultaneously. For this reason, the hydrogen producing device according to the present disclosure has a significantly superior hydrogen production efficiency because of wet and dry reforming decomposition of methane.

On the other hand, when hydrogen is produced only via the first reaction, which is the dry reforming reaction in which methane and carbon dioxide react, coke is formed on a catalyst because of thermal decomposition of methane (CH₄→C+2H₂). This results in low hydrogen production yield caused by low catalytic activity or low reactivity.

Specifically, in the reformer, the first reaction may proceed as a main reaction and the second reaction may proceed as a side reaction. Accordingly, compared to a case in which the second reaction proceeds as the main reaction and the first reaction proceeds as the side reaction, the device according to the present disclosure consumes a greater amount of carbon dioxide, which is a greenhouse gas. Thus, the disclosed device is more environmentally friendly.

In addition, in the reformer, the first reaction and the second reaction are performed simultaneously. Therefore, compared to a case in which the first reaction and the second reaction proceed sequentially, as most of methane in biogas is decomposed by carbon dioxide and water, an occurrence of coking caused by the thermal decomposition of methane is reduced. As efficiency of the first reaction (the dry reforming reaction) and the second reaction (the wet reforming reaction) is improved, the hydrogen production yield is maximized.

Because the first reaction and the second reaction as described above are endothermic reactions, a heat source that supplies heat necessary for the reaction within the reformer may be additionally included. The heat source may be used without particular limitation as long as it may be commonly used as a heat source during the endothermic reaction. The heat source may be, for example, a burner, a heat exchanger, and the like.

In addition, the reformer may include one or more types selected from a group consisting of a catalyst that performs the dry reforming reaction, which is the first reaction, and a catalyst that performs the wet reforming reaction, which is the second reaction. The catalyst for each reaction may be used without particular limitation as long as it may be commonly used in the reforming reaction and may be prepared and/or purchased.

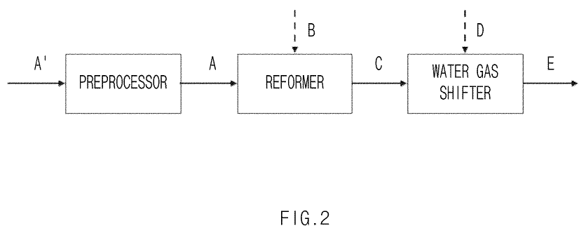

Referring to FIG. 2, the hydrogen producing device according to the present disclosure may include a preprocessor that is connected to a front end of the reformer and that removes a sulfur compound and a siloxane compound contained in biogas ‘A″ before supplying the biogas’ A’ to the reformer.

### Preprocessor

The preprocessor serves to remove the sulfur compound and the siloxane compound from biogas. For example, the preprocessor increases purity of produced hydrogen and prevents deterioration of the reforming catalyst by removing the sulfur compound, the siloxane compound, foreign substances, and the like contained in biogas.

In this regard, the preprocessor may be used without particular limitation as long as it may be commonly used to remove the foreign substances such as the sulfur compound and the siloxane compound in biogas.

First preheater

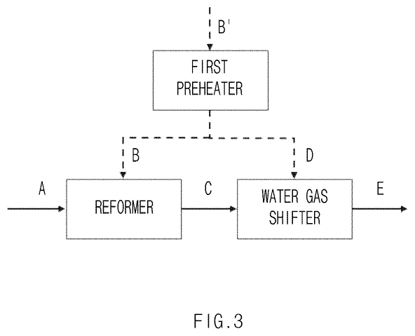

Water to be supplied to the reformer and a water gas shifter may be preheated. Referring to FIG. 3, the hydrogen producing device may include the first preheater that preheats the water ‘B’ to be supplied below to the reformer and water ‘D’ to be supplied below to the water gas shifter.

In addition, the first preheater preheats water to be used in the second reaction induced by the reformer and a third reaction induced by the water gas shifter, thereby improving reactivity of the second reaction and the third reaction and saving energy necessary for heating the reactor.

In this regard, the first preheater may use waste heat of the reformer as the heat source. Accordingly, energy efficiency of the device according to the present disclosure may be further improved. In other words, the waste heat of the reformer may be used as the heat source to preheat water to be supplied to the reformer and the water gas shifter.

Water gas shifter

In the water gas shifter, the third reaction (the water gas shift reaction, WGS) (CO+H₂O→CO₂+H₂) of carbon monoxide contained in the first gas and separately supplied water is induced to produce second gas containing hydrogen and carbon dioxide.

In addition, the water gas shifter may include a catalyst that performs the water gas shift reaction (WGS), which is the third reaction. The WGS catalyst may be used without particular limitation as long as it may be commonly used in the WGS and may be prepared and/or purchased.

Water to be supplied to the reformer and the water gas shifter may be preheated. In this regard, the preheating of water to be supplied to the reformer may be performed simultaneously with the preheating of water to be supplied for the third reaction (the water gas reaction) in the water gas shifter.

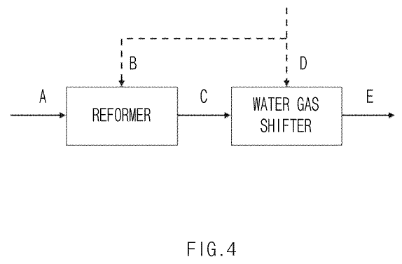

Specifically, referring to FIG. 4, the water ‘D’ to be supplied to the water gas shifter may be preheated to improve reactivity of the third reaction. In this regard, the preheated water may also be supplied to the reformer.

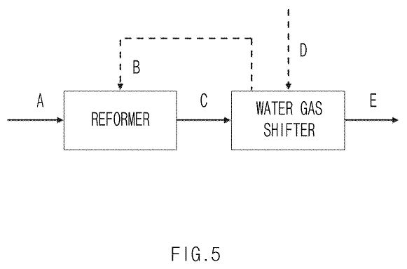

Additionally, referring to FIG. 5, the water ‘D’ to be supplied to the water gas shifter may be preheated to improve the reactivity of the third reaction. In this regard, the preheated water may also be supplied to the reformer. Specifically, water supplied to the reformer may be supplied from the water gas shifter. In this regard, water supplied to the reformer may be water preheated in the water gas shifter.

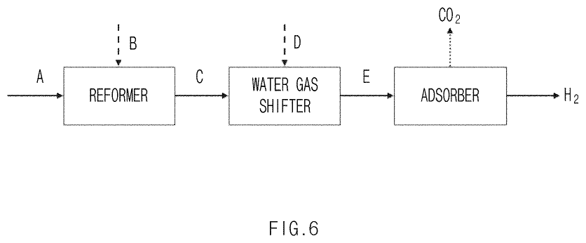

Referring to FIG. 6, the hydrogen producing device according to the present disclosure may include an adsorber that separates second gas ‘E’ discharged from the water gas shifter and that discharges hydrogen gas.

### Adsorber

The adsorber serves to adsorb, separate, and discharge hydrogen gas from the second gas. In this regard, the adsorber may separate the second gas discharged from the water gas shifter into high-purity hydrogen gas and carbon dioxide via the adsorption.

In addition, the adsorber may be used without particular limitation as long as it may be commonly used to adsorb and separate hydrogen gas from mixed gas. For example, this may be performed via pressure swing adsorption (PSA).

The adsorber may be composed of a plurality of, 3 or more, or 12 or less adsorption towers, and the adsorption tower may be filled with an adsorbent. In this regard, the adsorbent may be used without particular limitation as long as it may be commonly used in purification of hydrogen gas. For example, the adsorbent may be a carbon-based material, a zeolite-based material, and the like, and may specifically include activated carbon, aluminosilicate, pure silicate, titanosilicate, aluminophosphate, and the like.

Additionally, carbon dioxide discharged from the adsorber may be supplied to the reformer and reused. Biogas may contain 15% by volume or more, and in some examples, 18% by volume or more, 20% by volume or more, and may contain 45% by volume or less, and in some examples, 43% by volume or less, or 40% by volume or less of carbon dioxide. Accordingly, as a carbon dioxide content in biogas for the dry reforming reaction is insufficient, the hydrogen production yield may be low. As methane remains in the biogas and is thermally decomposed, the coking may occur and activity of the reforming catalyst may be reduced. However, when carbon dioxide is reused as described above, environmental friendliness is improved as emission of carbon dioxide, which is the greenhouse gas, is reduced. Also, the hydrogen production yield is improved because of an appropriate content of carbon dioxide participating in the dry reforming reaction. Also, the decrease in the catalytic activity is prevented as the occurrence of coking caused by residual methane is also reduced.

Second preheater

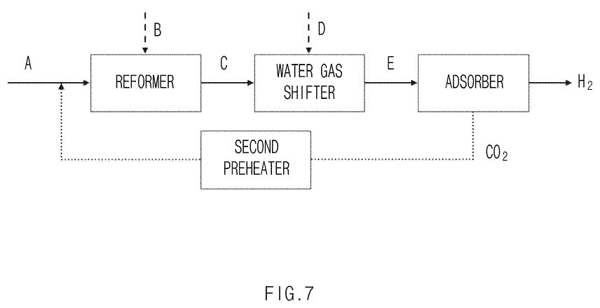

Referring to FIG. 7, the hydrogen producing device according to the present disclosure may include the second preheater that preheats carbon dioxide that is to be supplied to the reformer and reused.

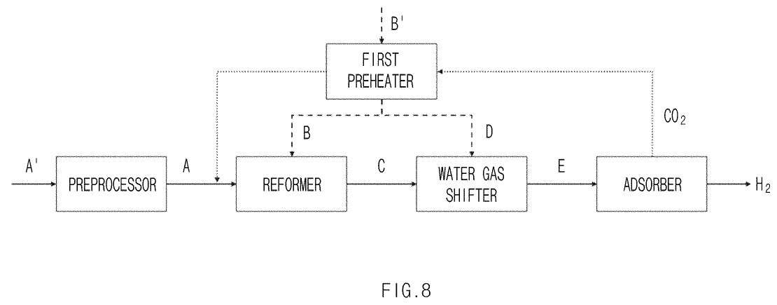

Further, referring to FIG. 8, in the hydrogen producing device according to the present disclosure, carbon dioxide discharged from the adsorber and to be supplied to the reformer and reused may be preheated in the first preheater. That is to say, the first preheater may preheat the water ‘B’ to be supplied to the reformer and the water ‘D’ to be supplied to the water gas shifter. The first preheater may also preheat carbon dioxide to be reused.

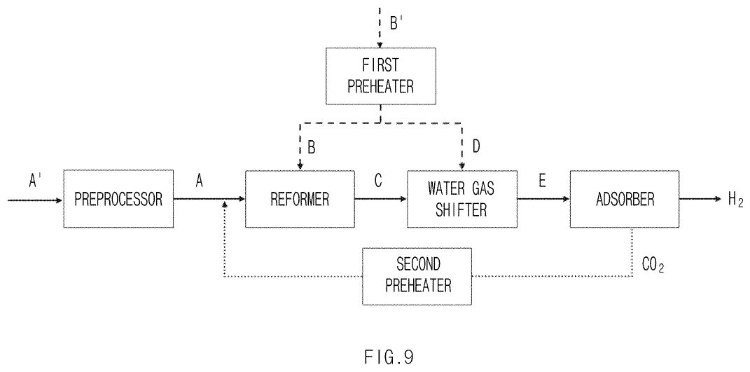

Referring to FIG. 9, the hydrogen producing device according to the present disclosure may include the preprocessor that receives the biogas ‘A″ and removes the sulfur compound and the siloxane compound contained in the biogas ‘A″. The device may also include the reformer that receives the preprocessed biogas ‘A’ and the water ‘B’ and generates the first gas ‘C’ by inducing the first reaction, which is the dry reforming reaction, and the second reaction, which is the wet reforming reaction. The device may further include the water gas shifter that receives the first gas ‘C’ and the water ‘D’ and generates the second gas ‘E’ by inducing the third reaction, which is the water gas conversion. The device may also include the adsorber that receives, adsorbs, and separates the second gas ‘E’ and discharges hydrogen gas and carbon dioxide. The device may further include the second preheater that preheats carbon dioxide discharged from the adsorber and supplies preheated carbon dioxide to the reformer.

The device may also include the first preheater that receives and preheats water “B” and supplies the preheated water “B” to the reformer and the water gas shifter.

In addition, hydrogen gas discharged from the adsorber has a purity of 99% or higher, and in some examples, 99.9% or higher, or 99.97% or higher. Thus, the discharged hydrogen gas is able to be used as a raw material for a fuel cell and the like even without additional purification.

Method for producing hydrogen

The method for producing hydrogen according to the present disclosure includes a reforming step and a water gas shifting step.

The method for producing hydrogen sequentially includes the reforming step and the water gas shifting step. Thus, the water gas shift reaction proceeds after the reforming reaction of methane, resulting in the excellent hydrogen production yield.

Reforming step

In the reforming step, the first gas containing hydrogen and carbon monoxide is generated from the first reaction of methane and carbon dioxide contained in biogas. The second reaction of methane contained in biogas and separately supplied water.

Specifically, in the reforming step, the first reaction (CH₄+CO₂→2H₂+2CO), which is the dry reforming reaction (DR) in which methane and carbon dioxide react, and the second reaction (CH₄+H₂O→3H₂+CO), which is the wet reforming reaction (the steam methane reforming (SMR)) in which methane and water react are performed simultaneously. For this reason, the hydrogen producing method according to the present disclosure has the significantly superior hydrogen production efficiency because of the wet reforming reaction and the dry reforming reaction of methane.

On the other hand, when hydrogen is produced only via the first reaction, which is the dry reforming reaction in which methane and carbon dioxide react, the coke is formed on the catalyst because of the thermal decomposition of methane (CH₄→C+2H₂). This results in the low hydrogen production yield caused by the low catalytic activity or the low reactivity.

In addition, when hydrogen is produced only via the second reaction, which is the wet reforming reaction in which methane and water react, a preprocessing process to separate biogas, which is a raw material, into methane and carbon dioxide is required, which may complicate the process.

Specifically, in the reforming step, the first reaction may proceed as the main reaction and the second reaction may proceed as the side reaction. Accordingly, compared to the case in which the second reaction proceeds as the main reaction and the first reaction proceeds as the side reaction, the producing method according to the present disclosure consumes a greater amount of carbon dioxide, which is the greenhouse gas, thereby having the excellent environmental friendliness and the excellent hydrogen production yield.

In addition, in the reforming step, the first reaction and the second reaction are performed simultaneously. Therefore, compared to the case in which the first reaction and the second reaction proceed sequentially, as most of the methane in the biogas is decomposed by carbon dioxide and water, the occurrence of the coking caused by the thermal decomposition of methane is reduced. As the efficiency of the first reaction (the dry reforming reaction) and the second reaction (the wet reforming reaction) is improved, the hydrogen production yield is maximized.

Because the first reaction and the second reaction as described above are the endothermic reactions, the heat source that supplies the heat necessary for the reaction within the reformer may be additionally included. The heat source may be used without particular limitation as long as it may be commonly used as the heat source during the endothermic reaction. The heat source may be, for example, the burner, the heat exchanger, and the like.

A temperature in the reforming step may be 700° C. or higher, and in some examples, may be 720° C. or higher, 730° C. or higher, 750° C. or higher, and may be 950° C. or lower, and in some examples, may be 940° C. or lower, 930° C. or lower, 910° C. or lower, or 900° C. or lower. When the temperature in the reforming step is within the above range, as the side reaction that causes the coking is suppressed, the decrease in the catalyst activity may be prevented. As efficiency of the methane reforming reaction is improved, the hydrogen production yield may be improved.

In addition, the reforming step may be performed in the presence of one or more types selected from a group comprising or consisting of the catalyst that performs the dry reforming reaction, which is the first reaction, and the catalyst that performs the wet reforming reaction, which is the second reaction. The catalyst for each reforming reaction may be used without particular limitation as long as it may be commonly used in the reforming reaction and may be prepared and/or purchased.

An amount of water supplied to the reforming step may be, based on 1 mole of methane contained in biogas supplied to the reforming step, 0.1 mole or greater, and in some examples, may be 0.35 mole or greater, 0.38 mole or greater, 0.40 mole or greater, 0.42 mole or greater, 0.45 mole or greater, 0.47 mole or greater, 0.48 mole or greater, and may be 0.65 mole or smaller, and in some examples, may be 0.63 mole or smaller, 0.61 mole or smaller, 0.60 mole or smaller, 0.58 mole or smaller, 0.56 mole or smaller, 0.55 mole or smaller, 0.53 mole or smaller, 0.52 mole or smaller, 0.51 mole or smaller, or 0.50 mole or smaller. When the amount of water supplied to the reforming step is within the above range, as a yield of the methane reforming reaction is improved, the hydrogen production yield may be improved. As the thermal decomposition reaction of methane is reduced, the side reaction that causes the coking may be suppressed and the decrease in the activity of the catalyst may be prevented.

The method for producing hydrogen according to the present disclosure may include a preprocessing step that is performed before the reforming step and that removes the sulfur compound and the siloxane compound contained in biogas before supplying biogas to the reforming step.

Preprocessing step

For example, the preprocessing step may increase the purity of produced hydrogen by removing the sulfur compound, the siloxane compound, the foreign substances, and the like contained in biogas.

The preprocessing step may be used without particular limitation as long as it may be commonly used to remove the foreign substances such as the sulfur compound and the siloxane compound in biogas.

First preheating step

Water to be supplied to the reforming step and the water gas shifting step below may be preheated. Specifically, the method for producing hydrogen may include the first preheating step of preheating water to be supplied to the reforming step and water to be supplied to the water gas shifting step below.

In addition, the first preheating step may improve the reactivity of the second reaction and the third reaction by preheating water to be used in the second reaction in the reforming step and the third reaction in the water gas shifting step.

In this regard, the first preheating step may use waste heat of the reforming step as the heat source. Therefore, the energy efficiency of the producing method according to the present disclosure may be further improved. In other words, the waste heat of the reforming step may be used as the heat source to preheat water to be supplied to the reforming step and the water gas shifting step.

Water preheated in the first preheating step may have a temperature of 150° C. or higher, and in some examples, may be 160° C. or higher, 170° C. or higher, 190° C. or higher, 200° C. or higher, and may be 350° C. or lower, and in some examples, may be 340° C. or lower, 330° C. or lower, 310° C. or lower, or 300° C. or lower. When the temperature of water preheated in the first preheating step is within the above range, the energy required for heating the reformer is saved.

Water gas shifting step

In the water gas shifting step, the second gas containing hydrogen and carbon dioxide is generated by the third reaction (water gas shift reaction, WGS) (CO+H₂O→CO₂+H₂) of carbon monoxide contained in the first gas and separately supplied water.

In addition, the water gas shifting step may be performed in the presence of the catalyst for the water gas shift reaction (WGS), which is the third reaction. The catalyst for the WGS may be used without particular limitation as long as it may be commonly used in the WGS and may be prepared and/or purchased.

Water to be supplied to the reforming step and the water gas shifting step may be preheated. In this regard, the preheating of water to be supplied to the reforming step may be performed simultaneously with the preheating of water to be supplied for the third reaction (the water gas shift reaction) of the water gas shifting step. Specifically, water to be supplied to the water gas shifting step may be preheated to improve the reactivity of the third reaction. In this regard, preheated water may also be supplied to the reforming step (see FIG. 4).

Additionally, water to be supplied to the water gas shifting step may be preheated to improve the reactivity of the third reaction. In this regard, preheated water may also be supplied to the reforming step. Specifically, water to be supplied to the reforming step may be supplied from the water gas shifting step. In this regard, water to be supplied to the reforming step may be water preheated in the water gas shifting step (see FIG. 5).

The method for producing hydrogen according to the present disclosure may include an adsorbing step of separating the second gas discharged from the water gas shifting step to discharge hydrogen gas.

Adsorbing step

The adsorbing step may adsorb and separate the second gas discharged from the water gas shifting step and may discharge the same by separating the same into high-purity hydrogen gas and carbon dioxide.

In addition, the adsorbing step may be used without particular limitation as long as it may be commonly used to adsorb and separate hydrogen gas from mixed gas. For example, this may be performed via the pressure swing adsorption (PSA).

Carbon dioxide discharged from the adsorbing step may be supplied to the reforming step and reused. Biogas supplied as the raw material may contain 15% by volume or more, and in some examples, 18% by volume or more, 20% by volume or more, and may contain 45% by volume or less, and in some examples, may contain 43% by volume or less, or 40% by volume or less of carbon dioxide. Accordingly, as the carbon dioxide content in biogas for the dry reforming reaction is insufficient, the hydrogen production yield may be low. As methane remains in biogas and is thermally decomposed, the coking may occur and the activity of the reforming catalyst may be reduced. However, when carbon dioxide is reused as described above, the environmental friendliness is improved as the emission of carbon dioxide, which is the greenhouse gas, is reduced. Also, the hydrogen production yield is improved because of the appropriate content of carbon dioxide participating in the dry reforming reaction. Also, the decrease in the catalytic activity is prevented as the occurrence of coking caused by residual methane is also reduced.

In addition, carbon dioxide supplied to the reforming step and reused may be supplied such that, based on 1 mole of methane contained in biogas supplied to the reforming step, a total number of moles of carbon dioxide supplied to the reforming step is 0.8 mole or greater, and in some examples, may be 0.85 mole or greater, 0.95 mole or greater, 0.96 mole or greater, 0.97 mole or greater, 0.98 mole or greater, 0.99 mole or greater, 1.0 mole or greater, and may be 1.25 mole or smaller, and in some examples, may be 1.24 mole or smaller, 1.23 mole or smaller, 1.22 mole or smaller, 1.21 mole or smaller, or 1.20 mole or smaller. When the total number of moles of carbon dioxide supplied to the reforming step is within the above range, yield of the methane dry reforming reaction is maximized, resulting in the excellent hydrogen production yield.

Second preheating step

The method for producing hydrogen according to the present disclosure may include the second preheating step of preheating carbon dioxide that is supplied to the reforming step and reused.

Carbon dioxide preheated in the second preheating step may have a temperature of 700° C. or higher, and in some examples, 720° C. or higher, 730° C. or higher, 750° C. or higher, and may be 950° C. or lower, and in some examples, 940° C. or lower, 930° C. or lower, 910° C. or lower, or 900° C. or lower. When the temperature of carbon dioxide preheated in the second preheating step is within the above range, the efficiency of the methane reforming reaction may be improved. Thus, the hydrogen production yield may be improved.

The method for producing hydrogen according to the present disclosure as described above has the excellent hydrogen production yield as the dry reforming and the wet reforming proceed simultaneously by separately supplying water during the reforming reaction. In addition, the method for producing hydrogen prevents the decrease in the activity of the reforming catalyst as the occurrence of coking caused by the thermal decomposition of methane is reduced.

The hydrogen producing method according to the present disclosure has excellent hydrogen production yield as the dry reforming and the wet reforming proceed simultaneously by separately supplying water during the reforming reaction. In addition, the hydrogen producing method prevents the decrease in the activity of the reforming catalyst as the occurrence of coking caused by the thermal decomposition of methane is reduced.

Hereinabove, although the present disclosure has been described with reference to various embodiments and the accompanying drawings, the present disclosure is not limited thereto. The embodiments may be variously modified and altered by those of ordinary skill in the art to which the present disclosure pertains without departing from the spirit and scope of the present disclosure claimed in the following claims.

What is claimed is:

1. A device for producing hydrogen, the device comprising:
a reformer configured to generate a first gas containing hydrogen and carbon monoxide by inducing a first reaction of methane and carbon dioxide contained in biogas and a second reaction of methane contained in biogas and separately supplied water; and
a water gas shifter configured to generate a second gas containing hydrogen and carbon dioxide by inducing a third reaction of carbon monoxide contained in the first gas and separately supplied water.

2. The device of claim 1, further comprising:
a preprocessor connected to a front end of the reformer and configured to remove a sulfur compound and a siloxane compound contained in biogas before supplying the biogas to the reformer.

3. The device of claim 1, further comprising:
a first preheater configured to preheat water to be supplied to the reformer and the water gas shifter.

4. The device of claim 3, wherein the first preheater uses waste heat of the reformer as a heat source.

5. The device of claim 1, further comprising:
an adsorber configured to separate the second gas discharged from the water gas shifter and discharge hydrogen gas.

6. The device of claim 5, wherein carbon dioxide discharged from the adsorber is supplied to the reformer and reused.

7. The device of claim 6, further comprising:
a second preheater configured to preheat carbon dioxide to be supplied to the reformer and reused.

8. A method for producing hydrogen, the method comprising:
a reforming step of generating a first gas containing hydrogen and carbon monoxide from a first reaction of methane and carbon dioxide contained in biogas and a second reaction of methane contained in biogas and separately supplied water; and
a water gas shifting step of generating a second gas containing hydrogen and carbon dioxide by reacting carbon monoxide contained in the first gas with separately supplied water.

9. The method of claim 8, wherein the reforming step is performed at a temperature equal to or higher than 700° C. and equal to or lower than 950° C.

10. The method of claim 8, wherein water supplied to the reforming step is supplied from the water gas shifting step.

11. The method of claim 8, wherein an amount of water supplied to the reforming step is 0.10 mole or greater and 0.50 mole or smaller based on 1 mole of methane contained in the biogas supplied to the reforming step.

12. The method of claim 8, further comprising:
a first preheating step of preheating water to be supplied to the reforming step and the water gas shifting step.

13. The method of claim 8, further comprising:
an adsorbing step of separating the second gas discharged from the water gas shifting step and discharging hydrogen gas.

14. The method of claim 13, wherein carbon dioxide discharged from the adsorbing step is supplied to the reforming step and reused.

15. The method of claim 14, wherein the carbon dioxide supplied to the reforming step and reused is supplied such that a total number of moles of the carbon dioxide supplied to the reforming step is equal to or greater than 0.8 mole and equal to or smaller than 1.2 mole, based on 1 mole of methane contained in biogas supplied to the reforming step.

16. The method of claim 14, further comprising:
a second preheating step of preheating the carbon dioxide to be supplied to the reforming step and reused.
